(19) United States
(12) Patent Application Publication
(10) Pub. No.: US 2014/0279632 A1
(43) Pub. Date: Sep. 18, 2014

(54) PROGRESSIVE JOB BOARD

(71) Applicant: APOLLO GROUP, INC., Phoenix, AZ (US)

(72) Inventors: Johnathan Andersen, Oakland, CA (US); Jason Brightman, Oakland, CA (US)

(73) Assignee: APOLLO GROUP, INC., Phoenix, AZ (US)

(21) Appl. No.: 13/834,438

(22) Filed: Mar. 15, 2013

Related U.S. Application Data
(63) Continuation of application No. 13/829,535, filed on Mar. 14, 2013.

(51) Int. Cl. G06Q 10/10

(52) U.S. Cl. CPC G06Q 10/1053
USPC 705/321

(57) ABSTRACT

A method is provided for displaying to a candidate one or more candidate-views. Specifically, a candidate may be presented with one or more jobs based on the candidate's possessed proficiencies. Tools and resources are provided to assess and increase a candidate's possessed proficiencies. A method is also provided for displaying, to an employer, employer-views. Specifically, employer-views may be used to define the required proficiencies for a job, find qualified candidates, and retrieve detailed candidate profile information comprising possessed proficiencies for one or more skills. Furthermore, a method is provided for displaying to an educator one or more educator-views. Specifically, a ranked list of skills may be presented to educators based on the number of candidates that may further their respective careers by increasing a particular proficiency. Educator-views may also provide educators with a space to post course information and materials.

### CROSS-REFERENCE TO RELATED APPLICATIONS

This application is a Continuation of U.S. patent application Ser. No. 13/829,535, filed Mar. 14, 2013, the entire contents of which is hereby incorporated by reference for all purposes as if fully set forth herein. The applicant(s) hereby rescind any disclaimer of claim scope in the parent application(s) or the prosecution history thereof and advise the USPTO that the claims in this application may be broader than any claim in the parent application(s).

This application is related to U.S. patent application Ser. No. 13/______, [Attorney Docket No. 60201-0219] filed the same day herewith, the entire contents of which is hereby incorporated by reference for all purposes as if fully set forth herein.

### FIELD OF THE INVENTION

The present invention relates to employment applications and, more specifically, to job boards.

### BACKGROUND

Conventional job boards return a list of jobs based on one or more keywords in a search, regardless of a candidate's career path or proficiency in various skills. Consequently, upon receipt of the keyword-based search results, users often find themselves wading through large numbers of job postings that are ill-suited to their qualifications.

Employers use job boards to find qualified, capable candidates. Unfortunately, employers are often left on their own to determine whether a candidate actually has the necessary proficiency in each required skill to perform a particular job. In many cases, employers are forced to determine a candidate's proficiency in various skills based solely on a resume, transcript, and/or a short interview.

Previously, employers assumed that a degree from a university meant a candidate had the requisite skills and proficiencies to perform a particular job. Employers now realize, however, that in many cases there is a gap between having a degree and having the necessary skills and proficiencies to succeed at a particular job.

Educators, who train candidates, typically are not involved with job boards at all. Thus, educators may receive little feedback from students and employers as to how well a particular course teaches a particular skill.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a candidate profile, according to an embodiment.

FIG. 2 illustrates a job-listings view, according to an embodiment.

FIG. 3 illustrates a job-candidate comparison view, according to an embodiment.

FIG. 4 illustrates various courses that may be offered to improve the possessed proficiency in a particular skill, according to an embodiment.

FIG. 5 illustrates various user-centered design courses offered by various schools, according to an embodiment.

FIG. 6 illustrates a detailed course description, according to an embodiment.

FIG. 7 illustrates a lesson, according to an embodiment.

FIG. 8 illustrates a lesson to improve a candidate's math proficiency, according to an embodiment.

FIG. 9 illustrates a job-creation view, according to an embodiment.

FIG. 10 illustrates candidate-listing view 1000, according to an embodiment.

FIG. 11 illustrates a candidate summary view, according to an embodiment.

FIG. 12 illustrates a skill-demand view, according to an embodiment.

FIG. 13 illustrates a materials view, according to an embodiment.

FIG. 14 illustrates a detailed job description for a particular job, according to an embodiment

FIG. 15 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Terms and Notation

For purpose of explanation, the following terms and conventions are used herein to describe embodiments of the invention:

The term “employer” herein may refer to either an employer, or an employer's representative. For example, an employer may be a solo practitioner that would like to hire an employee. Alternatively, an employer may be one or more human resource personnel, responsible for recruiting at a particular company.

The term “proficiency” herein describes the knowledge, experience, education, or other training in a particular skill. Proficiency may be measured many different ways, as discussed in detail below. Proficiency may be represented using numbers, levels, percentages, or any other method that can be used to quantize an amount of knowledge, experience, education, or training a person has.

The term “possessed proficiency” herein describes the proficiency that a candidate possesses in a particular skill. For example, a candidate may have worked as an interface designer for five years. Therefore, the candidate may have a possessed proficiency of five. In another example, a candidate may have taken two out of three design classes offered at a particular school. Therefore, the candidate may have a possessed proficiency of 66%.

The term “required proficiency” herein describes the proficiency required in a particular skill for a particular job. For example, a job may require three years of experience as a database administrator. Therefore, the required proficiency level for database administration may be three. In another example, a job may require a graduate degree in computer science.

The term “proficiency delta” herein describes the difference between a candidate's possessed proficiency and a job's required proficiency in a particular skill. For example, a candidate may have three years of experience working as a database administrator, and a job may require five years of experience working as a database administrator. Therefore, the proficiency delta may be two, 40%, or any other value to describe the difference between a candidate's possessed proficiency and the job's required proficiency.

The term “job-candidate match” herein describes the similarity between the candidate's possessed proficiencies and a job's required proficiencies for all skills required for the job. For example, a candidate may have worked as an interface designer for five years and taken three design classes at a particular college, and a job may require five years of experience as an interface designer and five design classes at a particular college. Therefore, the job-candidate match may be eight, 80%, or any other value to describe the similarities between a candidate's possessed proficiencies and a job's required proficiencies for all skills required for the job.

### General Overview

A method is provided for displaying to a candidate one or more candidate-views. Specifically, a candidate may be presented with one or more jobs based, at least in part, on the candidate's possessed proficiencies. Furthermore, tools and resources are provided to assess and increase a candidate's possessed proficiencies in order to qualify the candidate for better jobs.

A method is also provided for displaying to an employer one or more employer-views. Specifically, employer-views may be used to define the required proficiencies for a job, find qualified candidates, and retrieve detailed candidate profile information comprising possessed proficiencies for one or more skills.

Furthermore, a method is provided for displaying to an educator one or more educator-views. Specifically, a ranked list of skills may be presented to educators based, at least in part, on the number of candidates that may further their respective careers by increasing a particular proficiency, and the number of jobs available that require the particular proficiency. Educator-views may also provide educators with a space to post course information and materials. Course takers and employers may rate a course's effectiveness in increasing proficiency of a particular skill

### Candidate-Views

Candidate-views may be a collection of views for updating a candidate profile, searching for jobs, assessing candidate proficiencies, improving proficiencies, and comparing possessed proficiencies to required proficiencies for one or more jobs. A candidate-view may be, or at least part of, a website or application.

### Candidate Profile

FIG. 1 is a block diagram that illustrates a candidate profile, according to an embodiment. While FIG. 1 illustrates one embodiment for purposes of illustrating a clear example, other embodiments may omit, add to, reorder and/or modify any of the elements shown.

In the embodiment illustrated in FIG. 1, candidate profile 100 includes skill 112, skill 114, skill 116, and skill 118, collectively referred to as skills 110. Each of skills 110 includes an indicator describing the possessed proficiency for each skill, respectively. Candidate profile 100 also includes biography 150, candidate photo 152, and suggested-skills-to-learn tab 154. Candidate profile 100 may also include, but is in no way limited to, contacts, one or more resumes, one or more transcripts, privacy restrictions, and settings.

The data used to populate a candidate profile may be uploaded or retrieved from a candidate, one or more social networks, or schools or professional organizations. For example, a candidate may choose to use a profile picture from the candidate's account on a social network, a resume posted on another social network, and a transcript from a college or university. Furthermore a semantic parser may be used to extract skills, experience, accomplishments, and other features in a resume, transcript, or other records that are useful in determining the skills and proficiencies of a candidate.

### Job-Listings View

Jobs in a job-listing view may be grouped into multiple lists, based, at least in part, on job-candidate matches. For example, all jobs where the job-candidate match is 90% or above may be in a first list. All jobs where the job-candidate match is 80% or above, but below 90%, may be in a second list, and so on.

FIG. 2 is a block diagram that illustrates a job-listings view with job lists displayed from left to right based, at least in part, on a candidate's possessed proficiencies, according to an embodiment. While FIG. 2 illustrates one embodiment for purposes of illustrating a clear example, other embodiments may omit, add to, reorder and/or modify any of the elements shown.

In the embodiment illustrated in FIG. 2, job-listings view 200 includes: job-lists 212 through 216, collectively referred to as job-lists 210; and jobs 221 through 229, collectively referred to as jobs 220. Job-list 212 includes jobs 221 through 223; job-list 214 includes jobs 224 through 226; and job-list 216 includes jobs 227 through 229. Job-lists 210 also include job-indicator 232, job-indicator 234, and job-indicator 236, respectively, and referred to herein as job-indicators 230.

Each of the job-lists 210 covers a particular range of job-candidate matches. Thus, a job-list may include one or more jobs, such that each job in the job-list has a job-candidate match within a particular range, denoted by job-indicators 230. For example, job-list 212 includes jobs wherein the job-candidate match is 90% or greater, as indicated by job-indicator 232. Job-list 214 includes jobs wherein the job-candidate match is 80% or above, but less than 90%, as indicated by job-indicator 234. And, job-list 216 includes jobs wherein the job-candidate match is 70% or above, but less than 80%, as indicated by job-indicator 236.

In an embodiment, as the candidate scrolls to the right, job-lists include jobs with lower job-candidate matches. If a job-list is empty, then the job-list may not be shown. Alternatively, an empty job-list, with a corresponding indicator, may be shown.

Jobs within a job-list may also be ordered based on various criteria. For example, the jobs within a job-list may be ordered based on each job's job-candidate match. For example, job 221 may have a higher job-candidate match than job 222. Thus, job 221 is listed before job 222. As an alternative, the jobs in a job-list may be ordered based on other criteria, such as salary, location or job title. The criteria used to order jobs within any job-list may be user-selectable, and may be different for each of the job-lists.

The jobs included in job-list 212 may be the candidate's current job at other companies, or jobs that the candidate is likely qualified for. Jobs included in job-list 214 may be one level up from the candidate's current job, and so forth. Jobs that are in subsequent lists may be jobs that the candidate is likely to have as the candidate advances in her career path.

In one embodiment, jobs that a candidate is overqualified for do not show up in any list. For example, a candidate that is a senior software developer may not be shown the job listing for a junior software developer, even though the candidate more than satisfies the skills requirements specified for the job.

Jobs with the same job title may be in more than one list. For example, one company may have different proficiency requirements than another company for a senior level developer. Thus, one company may have a job list for a senior level developer in a first job-list, and another company may have a job list for a senior level developer in a second job-list.

In an embodiment, generic jobs may be included. For example, a generic job listing for a mid-level software engineer may require a bachelor's degree and five years of experience. Jobs matching those proficiency requirements may be grouped in the generic job, such that the generic job becomes a job bucket, included in a job-list, and containing one or more jobs.

### Parameters for Jobs Included in the Job-Listings View

The jobs included in a job-listings view may be based, at least in part, on one or more parameters. In an embodiment, a set of default parameters are used to present the candidate with at least an initial set of jobs the candidate may be interested in. For example, in FIG. 2, parameter 242, parameter 244, and parameter 246 may affect the jobs returned in job-listings view 200, based, at least in part, on particular assumptions that the candidate wants to: 1) advance, but not change, her career path; 2) change employers; and 3) stay in the same geographic area, respectively. A candidate may remove or add parameters as desired to narrow, broaden, or in some other way change the jobs returned in the job-listings view. For example, a user may provide parameters to the job-listings view, such that the jobs returned are in a particular industry, offer a particular minimum salary, or offer particular benefits.

### Career Path

A candidate may be presented with jobs in the job-listings view that further the candidate's career path, without entering a search string. A career path may be determined based, at least in part, on pattern matching. For example, pattern matching may be used to determine a career path based, at least in part, on jobs the candidate has had, education the candidate has received, or organizations the candidate is a member of. Other criteria may also be used to determine a candidate's career path. For example, pattern matching may be used to determine a career path based, at least in part, on jobs taken by those with similar resumes, education, and organizational memberships.

Alternatively, a candidate may wish to change career paths. In such cases, a user my delete the parameter to advance the candidate's career path, and perform a search based, at least in part, on job titles, areas of practice, or other criteria. The job-listings view may still present the candidate with jobs based on the job-candidate match; however, the jobs presented may not include a high job-candidate match.

### Idol and Idol Jobs

According to one embodiment, a database is maintained that indicates jobs and/or skill sets currently possessed by certain individuals. In such an embodiment, a candidate may select a person, from the database, whose job the candidate would like to have one day. In response, a career path for the candidate may be determined based, at least in part, on the job and/or skill set that is currently possessed by the person that was selected by the candidate.

Instead of picking a person, a candidate may select an “idol job” that the candidate aspires to obtain in the future. A job path may be determined based on what job the candidate currently has and what jobs will lead to the selected idol's job, or idol position.

### Change Employers

In some cases, a candidate may not want to be presented with jobs, in the job-listings view, that are offered by the candidate's current employer. For example, if a candidate works for Company X, it may be assumed that if the candidate could be promoted or take a different job at Company X, then the candidate would do so without the help of the job-listings view. In an embodiment, the setting to only list jobs with other employers may be a default setting. But, it may not always be the case that the candidate wants to change employers; accordingly, the user may override the default setting, thereby indicating that the candidate does not necessarily want to change employers.

### Stay in Current Location

A candidate may not want to be presented with jobs outside a particular geographic area, which the candidate currently lives or works in. Candidates may have family, friends, and property in a particular location. Thus, it may be prohibitively expensive or impractical for a candidate to move to a new geographic area to take a new job. Accordingly, the job-listings view may include jobs within the candidate's current home or employer. Alternatively, a candidate may select the geographic area that the candidate wants to work in or is willing to commute to. In some cases, a candidate may be indifferent to an employer's geographic location; accordingly, the candidate may specify that the job-listings view not limit the jobs presented to the candidate based on geographic location.

### Job-Candidate Comparison View

Candidates may be presented with a job-candidate comparison view, wherein the required proficiency level for each skill of a particular job is displayed. The candidate's possessed proficiencies may be presented and compared to the required proficiencies of the job, respectively.

FIG. 3 is a block diagram that illustrates a job-candidate comparison view, according to an embodiment. While FIG. 3 illustrates one embodiment for purposes of illustrating a clear example, other embodiments may omit, add to, reorder and/or modify any of the elements shown.

In the embodiment illustrated in FIG. 3, job-candidate comparison view 300 includes skill identifier 312, skill identifier 314, and skill identifier 316, collectively referred to herein as skill identifiers 310. Skill identifier 312, skill identifier 314, and skill identifier 316, include required proficiency indicator 322, required proficiency indicator 324, and required proficiency indicator 326, respectively. Skill identifier 312, skill identifier 314, and skill identifier 316, also include possessed proficiency indicator 332, possessed proficiency indicator 334, and possessed proficiency indicator 336, respectively. Job-candidate comparison view 300 includes job-candidate match 350.

Job-candidate comparison view 300 may include assess-skill link 370, which when clicked may assess the possessed proficiency of a candidate in the corresponding skill For example, if proficiency in a particular skill is based on a test score, then clicking assess-skills link 370 may take the candidate to an assessment tool that presents the candidate with a test. Alternatively, assess-skills link 370 may be a button, control, or simply information necessary for a candidate to update or log the possessed proficiency for a particular skill Assess-skills link 370 may also return a candidate to the candidate's profile to update the candidate's skills and respective proficiencies.

Job-candidate comparison view 300 may include an assess-skills link for each skill where the possessed proficiency is unknown. For example, and as illustrated in FIG. 3, assess-skills link 370 is located next to skill identifier 316, wherein the possessed proficiency is unknown, as indicated by the question mark icon. Alternatively, job-candidate comparison view 300 may include an assess-skills link for each skill of skill identifiers 310, regardless of the possessed proficiency.

Job-candidate comparison view 300 may include get-skills link 360, which when clicked may provide information on how to increase the possessed proficiency in a particular skill. For example, if proficiency in a particular skill is measured by the number of classes taken in a series of classes, get-skills link 360 may be a link to the next course in the series to increase proficiency. As another example, get-skills link 360 may link to a tutorial, upon completion of which, the candidate's possessed proficiency is automatically updated. Alternatively, get-skills link 360 may be a button, control, or simply information necessary for a candidate to increase proficiency in a particular skill.

Job-candidate comparison view 300 may include a get-skills link for each skill of skill identifiers 310 where the proficiency delta indicates that the possessed proficiency is less than the required proficiency. For example, and as illustrated in FIG. 3, get-skills link 360 is located next to skill identifier 314, wherein the proficiency delta may be one, or 20%. However, job-candidate comparison view 300 may include a get-skills link for each of skill identifiers 310, regardless of the required proficiency.

Job-candidate comparison view 300 may also include job title 380, employer name 381, job location 382, salary 384, job description 386, and other job details. Job-candidate comparison view 300 may link to other sources for information related to increasing proficiency, assessing skills, or job information.

Job-candidate comparison view 300 may have a link to apply for the job. Alternatively, job-candidate comparison view 300 may have a link or button to get more information regarding the particular job and how to apply. For example, FIG. 14 illustrates a detailed job description for a particular job, along with a link to learn how to apply for the particular job, according to an embodiment.

### Proficiency Assessment

Proficiency may be measured many different ways. For example, proficiency may be measured based, at least in part, on an exam score, work experience, current or previous job titles, particular classes taken, awards received, or any other training or experiences. A candidate may update her proficiency in many ways including uploading a resume or transcript, filling out a form, taking an online exam or quiz, or any other methods of evaluating proficiency in a particular skill. Proficiency may also be assessed by including data from social networking sites, e.g., LinkedIn.com and Facebook.com.

A proficiency assessment may be integrated into the same website or application as job-listings view 200, e.g., in a popup window. Alternatively, proficiency assessments may be taken through other websites, applications, or entities, e.g., university websites, testing center platforms, or technical training centers.

A candidate's proficiency may be updated by a third party through an application programming interface (“API”) or other mechanism. For example, software administering an exam may update the candidate's proficiency automatically through an API. A proctor may report an exam score, or a university may report successful completion of a course, a grade, or another mark indicating successful completion of one or more classes through an API. Alternatively, a report may be made by phone, email, carrier service, or any other method of communication.

### Tools or Resources to Improve Proficiency

Various tools or resources may be suggested or offered to a candidate to improve possessed proficiency. For example, FIG. 4 is a block diagram that illustrates various courses that may be offered to improve the possessed proficiency in a particular skill, according to an embodiment. The courses may include courses offered by partner-schools, schools in a particular area, online courses, teachers, subject matter experts, or organizations that can increase the proficiency of the particular skill. Furthermore, the courses offered may be based, at least in part, on the candidate's current proficiency in a skill.

Candidates may also compare courses and sign up for classes. For example, FIG. 5 is a block diagram that illustrates various user-centered design courses offered by various schools, according to an embodiment. The course name, cost, ratings, and course content are included in the comparison. Furthermore, one or more links may be provided for a candidate to register and pay for a particular course.

Candidates may also be given an option to view additional data regarding a particular course. For example, FIG. 6 is a block diagram that illustrates a detailed course description, which includes a schedule and information about the professor, according to an embodiment. The candidate may also be alerted regarding registration deadlines.

Further still, candidates may have access to additional tools and resources to improve proficiency. For example, FIG. 7 is a block diagram that illustrates a lesson about “Creating New Markets with Growth Innovation,” according to an embodiment. In another example, FIG. 8 is a block diagram that illustrates a lesson to improve a candidate's math proficiency, according to an embodiment. Tools may include, but are in no way limited to, additional website applications, videos, readings, tutorials, exams, and exercises. Furthermore, a candidate may submit assignments and additional content to be evaluated and the candidate's possessed proficiency for one or more skills may be automatically updated.

### Exemplary Experience

As merely an example in which candidates may use the candidate-views, the following exemplary process may be carried out, in an embodiment. This example is in no way meant to be limiting. While this example discusses particular steps according to an embodiment, other embodiments may omit, add to, reorder, and/or modify any of the steps below, based, at least in part, on the candidate, jobs available, and the particular methods used.

In step 1: A candidate logs in and selects to view either a candidate profile or available jobs. For example, after a candidate logs in to a progressive job board, the candidate may scroll left to view the candidate's profile, or right to view a job-listings view.

In step 2: A candidate's possessed proficiencies are assessed and a career path is determined. For example, the candidate may upload her resume and transcript. The user may also provide links and/or authorization to access her social networks. The candidate's possessed proficiency in various skills and her career path may be determined based, at least in part, on her transcript, resume, and data gathered from social networks.

In step 3: The candidate updates the possessed proficiency in a particular skill by taking an exam. For example, the candidate may feel that she has a higher proficiency at writing C++ programs than she is given credit for. Accordingly, the candidate takes a C++ assessment exam to update her possessed proficiency.

In step 4: The candidate browses the jobs available based, at least in part, on her career path and possessed proficiencies. For example, several job-lists may be displayed with one or more jobs in each job-list. Each job displayed may be projected to be within the candidate's career path. Furthermore, jobs that the candidate is over qualified for may be excluded.

In step 5: The candidate is presented with a job-candidate comparison view. For example, the candidate may click on one of the jobs in a job-list, and a popup window may be displayed, which contains a job-candidate comparison view.

In step 6: The candidate is presented with information to increase her possessed proficiency. For example, for a skill in which the proficiency delta is greater than one, the candidate may click on a link to view courses to increase her proficiency in the skill In response, the user may be presented with any of the views or combination of the views discussed above, including illustrated views in FIG. 4, FIG. 5, FIG. 6, and FIG. 7 to increase the user's proficiency in the skill.

In step 7: The candidate applies for one or more jobs. For example, a candidate may have a job-candidate match of ninety percent or better with a first job. The candidate may click a link to apply to the first job. A candidate may also apply to a second job, which has a lower job-candidate match; however, the candidate may be less likely to get the second job.

### Employer View

Employer-views may be a collection of views for posting available jobs and/or searching for qualified candidates. Employer-views may be, at least part of, a website or application. Employer-views may also be part of the same website or application that candidate-views are a part of.

### Job-Creation View

Employers may create and post a new job with a job-creation view. FIG. 9 is a block diagram that illustrates a job-creation view, according to an embodiment. While FIG. 9 illustrates one embodiment for purposes of illustrating a clear example, other embodiments may omit, add to, reorder and/or modify any of the elements shown.

In the embodiment illustrated in FIG. 9, job-creation view 900 includes skill record 911, skill record 912, skill record 913, skill record 914, skill record 915, and skill record 916. Each skill record may also include a slider, input, or some other mechanism, to set the required proficiency. For example, skill record 911 includes slider 921 to adjust the required proficiency. Each skill record may also include a candidate number indicator, e.g., candidate number indicator 931, which may indicate the number of candidates with that particular skill.

Job-creation view 900 also includes title 950, description 952, match number 954, applicant counter 956, and company logo 958. Job-creation view 900 may also include, but is in no way limited to, names of applicants that have applied, one or more submitted resumes, one or more submitted transcripts, privacy restrictions, and settings. The data used to populate a job-creation view may be uploaded or entered by an employer, recruiter, or other representative.

### Candidate-Listing View

A candidate-listing view may be similar to a job-listing view, but, instead of listing jobs, candidates are listed. Furthermore, candidates may be grouped into multiple lists, based, at least in part, on job-candidate matches. For example, all candidates for a job, where the job-candidate match is 90% or above may be in a first list. All candidates where the job-candidate match is 80% or above, but below 90%, may be in the second list, and so on.

FIG. 10 illustrates candidate-listing view 1000, according to an embodiment. While FIG. 10 illustrates one embodiment for purposes of illustrating a clear example, other embodiments may omit, add to, reorder and/or modify any of the elements shown.

In the embodiment illustrated in FIG. 10, candidate-listing view 1000 includes: candidate-lists 1012 through 1016, collectively referred to as candidate-lists 1010; and candidates 1021 through 1029, collectively referred to as candidates 1020. Candidate-list 1012 includes job-candidate-match indicator 1032, and candidates 1021 through 1023; candidate-list 1014 includes job-candidate-match indicator 1034, and candidates 1024 through 1026; and candidate-list 1016 includes job-candidate-match indicator 1036, and candidates 1027 through 1029.

Each of the candidate-lists 1010 includes candidates wherein the job-candidate match is within a particular range. For example, candidate-list 1012 includes candidates wherein the job-candidate match is 90% or greater; candidate-list 1014 includes candidates wherein the job-candidate match is 80% or above, but less than 90%; and candidate-list 1016 includes candidates wherein the job-candidate match is 70% or above, but less than 80%. As the candidate scrolls to the right, candidate-lists include candidates with lower job-candidate matches. Accordingly, candidates included in candidate-list 1012 may be the candidates with the same job at other companies or candidates that are likely qualified for the job. Candidates included in candidate-list 1014 may be less qualified than candidates in candidate-list 1012, and so forth. Candidates that are in subsequent lists may be cheaper, but may also need further training.

Candidates within a candidate-list may also be ordered based on each candidate's job-candidate match. For example, candidate 1021 may have a higher job-candidate match than candidate 1022. Thus, candidate 1021 is listed before candidate 1022. If a list is empty, the list may not be shown. Alternatively, an empty list could be shown.

Candidates that are overqualified may not show up in any list. For example, a candidate that is a senior software developer may not be in any of candidate lists 1010 for a junior software developer.

### Parameters for Candidates Included in the Candidate-Listing View

The candidates included in a candidate-listings view may be based, at least in part, on one or more parameters. In an embodiment, a set of default parameters are used to present the candidate with at least an initial set of candidates the employer may be interested in. For example, an employer my want to set parameters such that the candidate listing view may: 1) only include current employees; 2) exclude current employees; or 3) include candidate located within a particular geographic area. An employer may remove or add parameters as desired to narrow, broaden, or in some other way change the candidates returned in the candidate-listings view.

### Candidate Summary View

Employers may be presented with a candidate summary view. For example, FIG. 11 illustrates a candidate summary view, according to an embodiment. While FIG. 11 illustrates one embodiment for purposes of illustrating a clear example, other embodiments may omit, add to, reorder and/or modify any of the elements shown.

In the embodiment illustrated in FIG. 11, candidate summary view 1100 includes skill 1111, skill 1112, skill 1113, skill 1114, skill 1115, and skill 1116, collectively referred to herein as skills 1110. Skills 1110 include possessed proficiencies 1121 through 1126, respectively.

Candidate summary view 1100 may include skill match section 1130. Skill match section 1130 may include the required proficiency for each skill required for the job. Skill match section 1130 may also indicate whether the proficiency delta is greater than zero or a particular threshold. For example, in skill match section 1130, the candidate is merely 10% proficient in the user-centered design skill, accordingly that skill or possessed proficiency may be bolded, italicized, highlighted, or otherwise set apart.

Candidate summary view 1100 may also include candidate name 1152, candidate picture 1154, contact button 1156, and other job details. Candidate summary view 1100 may include, or link to, other information related to the candidate.

### Exemplary Experience

As merely an example, in which employers may use the employer-views, the following exemplary process may be carried out, in an embodiment. This example is in no way meant to be limiting. While this example discusses particular steps according to an embodiment, other embodiments may omit, add to, reorder, and/or modify any of the steps below, based, at least in part, on the employer, candidates available, and the particular methods used.

In step 1: An employer logs in and creates a job on the progressive job board. For example, an employer may login to a progressive job board website. The employer may click a link to create a job. In response, the user may be presented with a job-creation view.

In step 2: The employer selects the skills required for the job and the required proficiencies, respectively. For example, the employer selects a C++ skill and moves a slider to adjust the proficiency, such that the C++ skill requires eighty percent proficiency.

In step 3: The employer is presented with a candidate-listing view. For example, the employer may scroll to the right to reveal the candidate-listing view. The candidate listing view may include several candidate-lists, wherein each candidate list includes one or more candidates that have applied, or are qualified to some degree, to take the job.

In step 4: The employer is presented with a candidate summary. For example, the employer may click on a particular candidate that may be a good match. In response, the employer may see a candidate summary comparing the candidate's possessed proficiencies with the job's required proficiencies for the job.

In step 5: The employer offers a candidate a job. For example, upon determining that the candidate has the required proficiencies, the employer may click a link to submit an offer.

### Educator-Views

Educator-views may be a collection of views for determining which skills and proficiencies are most in demand, rating current courses offered, hosting course materials, or starting a new course. Educator-views may be part of a website or application. Educator-views may also be part of the same website or application that candidate-views and/or the employer-views are a part of.

### Skill-Demand View

A skill-demand view shows the skills that are in demand and provides additional statistics that may help users determine whether there is demand for a particular course on a particular subject. For example, FIG. 12 illustrates a skill-demand view, according to an embodiment. While FIG. 12 illustrates an embodiment for purposes of illustrating a clear example, other embodiments may omit, add to, reorder and/or modify any of the elements shown.

In the embodiment illustrated in FIG. 12, skill-demand view 1200 includes skill list 1205. Skill list 1205 may include skills that the user has achieved a particular high proficiency in. Skills 1210 may also be ordered by any statistic, including the statistics described below.

Details about the demand for any of the skills in skill list 12051210 may be available in skill-details view 1220. Skill-details view 1220 may include skill description 1222 and skill stats 1230.

Skill stats 1230 may include open-position statistic 1231, demand-for-skill statistic 1232, course-count statistic 1233, average-employer-rating statistic 1234, and average-student-rating statistic 1235. Open-position statistic 1231 may be the number of positions open that require the skill or proficiency. Demand-for-skill statistic 1232 may be the number of people that need that skill or proficiency, such that if a person had the skill or proficiency, then the person would be eligible for a new position. Course-count statistic 1233 may be the number of courses that currently teach the skill or proficiency. Average-employer-rating statistic 1234 may be the average rating given to each course teaching the skill or proficiency by employers. Average-student-rating statistic 1235 may be the average rating given to each course teaching the skill or proficiency by students or class participants.

In the example illustrated in FIG. 12, a teacher may wish to create a course focused on user-centered design since 1,502 people need the skill, but the ratings for the courses that teach the skill are low. Furthermore, a hiring manager may determine that it is easier, or more effective, to merely higher those without the skill and train the new employee in the skill, since the average rating for the courses are so low.

### Materials View

A teacher may post training materials, including lectures, papers, books, video, screen casts, instructions, assessments, and any other helpful training materials. For example, FIG. 13 illustrates a materials view, according to an embodiment. While FIG. 13 illustrates one embodiment for purposes of illustrating a clear example, other embodiments may omit, add to, reorder and/or modify any of the elements shown.

In the embodiment illustrated in FIG. 13, materials view 1300 includes instructional videos 1310 and instructional books 1320. Materials view 1300 also provides links 1330 to instructions and assessments for students taking the course.

### Exemplary Experience

As merely an example, in which educators may use the educator-views, the following exemplary process may be carried out, in an embodiment. This example is in no way meant to be limiting. While this example discusses particular steps according to an embodiment, other embodiments may omit, add to, reorder, and/or modify any of the steps below, based, at least in part, on the educator, candidates, employers, and the particular methods used.

In step 1: An educator logs in and is presented with a skill demand view. For example, a candidate who has been assessed to be a subject matter expert in one or more skills may login as an educator. Alternatively, a teacher at a college, university, or other educational organization may be deemed to be a subject matter expert in one or more skills, and may login as an educator. Upon logging in, the educator may click a link to see a skill demand view. The skill demand view may rank all of the skills the educator is a subject matter expert in, and order the skills by demand.

In step 2: The educator selects to teach a course based, at least in part, on the skill demand view. For example, the educator may observe that all of the courses teaching the top ranked skill have received low ratings from both employers and students. Accordingly, the educator may click a link to create a course teaching the skill.

In step 3: The educator is presented with a materials view. For example, after clicking the link to create the course the educator may be presented with the materials view, from which the educator can upload screen casts, audio lectures, books, assignments, exams, or any other material needed to teach the course.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 15 is a block diagram that illustrates a computer system 1500 upon which an embodiment of the invention may be implemented. Computer system 1500 includes a bus 1502 or other communication mechanism for communicating information, and a hardware processor 1504 coupled with bus 1502 for processing information. Hardware processor 1504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk or optical disk, is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware and/or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1510. Volatile media includes dynamic memory, such as main memory 1506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Other Aspects of Disclosure

Various novel features relating to the candidate views include, but are not limited to:

1. A method comprising: obtaining, for a user, a set of possessed-proficiency data that indicates a proficiency level currently possessed by the user in each of a plurality of skills; for each job of a plurality of jobs, obtaining a set of required-proficiency data that indicates proficiency levels required by the job for each of the plurality of skills; for each job of the plurality of jobs, determining a proficiency match based on a comparison between the set of possessed-proficiency data and the set of required-proficiency data of the job; generating a display that includes a plurality of indicators for the plurality of jobs; wherein each of the plurality of indicators corresponds to at least one of the plurality of jobs; wherein, within the display, the plurality of indicators are arranged in a manner that is based, at least in part, on one or more proficiency matches that were generated for the plurality of jobs that correspond to the plurality of indicators; wherein the method is performed by one or more processors.

2. The method of feature 1 wherein generating the display includes: grouping the plurality of jobs into a plurality of groups based, at least in part, on the one or more proficiency matches that were generated for the plurality of jobs; and arranging the plurality of indicators based on the plurality of groups to which the corresponding jobs belong.

3. The method of feature 2 wherein, within at least one of the plurality of groups, indicators are displayed in an order that is based on sort criteria other than the one or more proficiency matches.

4. The method of feature 2 wherein grouping the plurality of jobs into groups includes:

forming a first group in which the proficiency match for all jobs that belong to the first group is less than a first predetermined threshold; and

forming a second group in which the proficiency match for all jobs that belong to the second group is greater than the first predetermined threshold.

5. The method of feature 4 wherein:

the proficiency match for all jobs that belong to the second group is less than a second predetermined threshold; and

grouping the plurality of jobs into groups further includes forming a third group in which the proficiency match for all jobs that belong to the third group is greater than the second predetermined threshold.

6. The method of feature 1, wherein obtaining possessed-proficiency data includes presenting an assessment to the user to assess proficiency in a particular skill in response to determining that currently-available possessed-proficiency data for the user does not reflect actual proficiency of the user in the particular skill.

7. The method of feature 1, further comprising:

determining a deficiency in a particular skill based on the comparison between the set of possessed-proficiency data and the set of required-proficiency data of the job;

in response to detecting the deficiency in the particular skill, automatically displaying information to assist in developing the particular skill.

8. The method of feature 1, further comprising generating a particular display that includes information that reflects, for a particular job of the plurality of jobs, a comparison between the set of possessed-proficiency data, and the set of required-proficiency data for the particular job.

9. The method of feature 8 further comprising displaying, in the particular display, information relating to one or more courses for increasing proficiency of the user to a proficiency level required by the particular job.

10. The method of feature 8 further comprising: providing a control on the particular display, which when activated, shows one or more courses for increasing a proficiency level of the user to a proficiency level required by the particular job.

11. The method of feature 10 wherein: the proficiency level is a first proficiency level; the proficiency level required is a first proficiency level required; the control is a first control for displaying information about courses for increasing the first proficiency level of the user, relative to a first skill, to the first proficiency level required by the particular job for the first skill; and the particular display includes a second control for displaying information about courses for increasing a second proficiency level of the user, relative to a second skill, to a second proficiency level required by the particular job for the second skill.

12. The method of feature 1, wherein the plurality of jobs is a set of jobs based, at least in part, on an indication, by the user, that the user wants to remain on a career path that the user is currently on.

13. The method of feature 12, wherein the career path is a automatically determined based, at least in part, on possessed proficiencies, jobs the user has had, education the user has received, or organizations the user is a member of.

14. The method of feature 1, wherein: the plurality of jobs is a set of jobs based, at least in part, on a career path; and the career path is selected based, at least in part, on an idol selected by the user; the idol is a person with a particular job.

15.

15. The method of feature 1, wherein: wherein the plurality of jobs is a set of jobs based, at least in part, on a career path; and the career path is selected based, at least in part, on an idol position selected by the user.

16. The method of feature 1, wherein: the user is currently employed by an employer; and the plurality of jobs is a set of jobs based, at least in part, on the user selecting whether or not to include jobs available at the employer.

17. The method of feature 1, wherein the plurality of jobs is a set of jobs based, at least in part, on the user selecting a particular geographic region.

18. One or more non-transitory computer-readable medium storing instructions which, when executed by one or more processors, cause performance of a method recited in features 1-17.

Various novel features relating to the employer views include, but are not limited to:

1. A method comprising: obtaining, for a job, a set of required-proficiency data that indicates a proficiency level required by a candidate in each of a plurality of skills; for each candidate of a plurality of candidates, obtaining a set of possessed-proficiency data that indicates proficiency levels currently possessed by the candidate for each of the plurality of skills; for each candidate of the plurality of candidates, determining a proficiency match based on a comparison between the set of possessed-proficiency data and the set of required-proficiency data of the candidate; generating a display that includes a plurality of indicators for the plurality of candidates; wherein each of the plurality of indicators corresponds to at least one of the plurality of candidates; wherein, within the display, the plurality of indicators are arranged in a manner that is based, at least in part, on one or more proficiency matches that were generated for the plurality of candidates that correspond to the plurality of indicators; and wherein the method is performed by one or more processors.

2. The method of feature 1 wherein generating the display includes: grouping the plurality of candidates into a plurality of groups based, at least in part, on the one or more proficiency matches that were generated for the plurality of candidates; and arranging the plurality of indicators based on the plurality of groups to which the corresponding candidates belong.

3. The method of feature 2 wherein, within at least one of the plurality of groups, indicators are displayed in an order that is based on sort criteria other than the one or more proficiency matches.

4. The method of feature 2 wherein grouping the plurality of candidates into groups includes: forming a first group in which the proficiency match for all candidates that belong to the first group is less than a first predetermined threshold; and forming a second group in which the proficiency match for all candidates that belong to the second group is greater than the first predetermined threshold.

5. The method of feature 4 wherein: the proficiency match for all candidates that belong to the second group is less than a second predetermined threshold; and grouping the plurality of candidates into groups further includes forming a third group in which the proficiency match for all candidates that belong to the third group is greater than the second predetermined threshold.

6. The method of feature 1, further comprising generating a particular display that includes information that reflects, for a particular candidate of the plurality of candidates, a comparison between the set of required-proficiency data, and the set of possessed-proficiency data for the particular candidate.

7. The method of feature 1, wherein: the job is posted by an employer; and the plurality of candidates includes candidates that are currently employed by the employer and have indicated that they are interested in jobs of available at their current employer; and candidates that are currently employed by other employers, and have indicated that they are interested in jobs with employers other than their current employer.

8. The method of feature 1, wherein: the job is posted by an employer; and the plurality of candidates is a set of candidates that were selected based, at least in part, on the set of candidates having expressed an interest in a geographic region that is associated with the employer.

9. The method of feature 1 wherein: the proficiency match that is above a certain threshold is deemed to indicate that the candidate is overqualified for the job; one or more candidates of the plurality of candidates have a proficiency match that is above the certain threshold; and the display does not include an indicator for any of the one or more candidates.

10. The method of feature 1 further comprising generating a control which, when activated, enables creation of an offer of employment for a least one selected candidate of the plurality of candidates.

11. One or more non-transitory computer-readable medium storing instructions which, when executed by one or more processors, cause performance of a method recited in features 1-10.

Various novel features relating to the educator views include, but are not limited to:

1. A method comprising: obtaining, for a plurality of skills, a set of possessed-proficiency data that indicates a proficiency level currently possessed by each user of a plurality of users; obtaining, for the plurality of skills, a set of required-proficiency data that indicates a proficiency level currently required by each job of a plurality of jobs; for each skill of the plurality of skills, determining a demand based, at least in part, on the set of possessed-proficiency data and the set of required-proficiency data; and ranking the plurality of skills based on the demand for each skill; and wherein the method is performed by one or more processors.

2. The method of claim 1 further comprising generating a particular display, for a particular skill of the plurality of skills, that includes information that reflects the demand for the particular skill.

3. The method of claim 2 wherein the information that reflects demand includes information that reflects a number of open positions that require the particular skill.

4. The method of claim 2 wherein the information that reflects demand includes information that reflects how many users, of the plurality of users, need greater proficiency in the particular skill to qualify for a job of the plurality of jobs.

5. The method of claim 1 further comprising generating a particular display, for a particular skill of the plurality of skills, that includes information that reflects an average rating of a set of courses that teach the particular skill.

6. The method of claim 5, wherein the average rating is based, at least in part, on a rating given by students that have taken one or more courses in the set of courses.

7. The method of claim 5, wherein the average rating is based, at least in part, on a rating given by employers to one or more courses in the set of courses.

8. The method of claim 1 further comprising generating a particular display, for a particular skill of the plurality of skills, that that reflects how many courses that teach the particular skill.

9. The method of claim 1 further comprising: generating a particular display for a particular skill of the plurality of skills, and providing a control on the particular display, which when activated, creates a page for uploading content for a course to teach the particular skill.

10. A method comprising: obtaining, for a plurality of skills, a set of possessed-proficiency data that indicates a proficiency level currently possessed by each user of a plurality of users; obtaining, for the plurality of skills, a set of required-proficiency data that indicates a proficiency level currently required by each job of a plurality of jobs; for each skill of the plurality of skills, determining a demand based, at least in part, on the set of possessed-proficiency data and the set of required-proficiency data; and generating a particular display, for a particular skill of the plurality of skills, that includes information that reflects the demand for the particular skill; and wherein the method is performed by one or more processors.

11. The method of claim 10 wherein the information that reflects demand includes information that reflects a number of open positions that require the particular skill.

12. The method of claim 10 wherein the information that reflects demand includes information that reflects how many users, of the plurality of users, need greater proficiency in the particular skill to qualify for a job of the plurality of jobs.

13. One or more non-transitory computer-readable medium storing instructions which, when executed by one or more processors, cause performance of a method recited in features 1-12.

What is claimed is:

1. A method comprising:
obtaining, for a plurality of skills, a set of possessed-proficiency data that indicates a proficiency level currently possessed by each user of a plurality of users;
obtaining, for the plurality of skills, a set of required-proficiency data that indicates a proficiency level currently required by each job of a plurality of jobs;
for each skill of the plurality of skills, determining a demand based, at least in part, on the set of possessed-proficiency data and the set of required-proficiency data; and
ranking the plurality of skills based on the demand for each skill; and
wherein the method is performed by one or more processors.

2. The method of claim 1 further comprising generating a particular display, for a particular skill of the plurality of skills, that includes information that reflects the demand for the particular skill.

3. The method of claim 2 wherein the information that reflects demand includes information that reflects a number of open positions that require the particular skill.

4. The method of claim 2 wherein the information that reflects demand includes information that reflects how many users, of the plurality of users, need greater proficiency in the particular skill to qualify for a job of the plurality of jobs.

5. The method of claim 1 further comprising generating a particular display, for a particular skill of the plurality of skills, that includes information that reflects an average rating of a set of courses that teach the particular skill.

6. The method of claim 5, wherein the average rating is based, at least in part, on a rating given by students that have taken one or more courses in the set of courses.

7. The method of claim 5, wherein the average rating is based, at least in part, on a rating given by employers to one or more courses in the set of courses.

8. The method of claim 1 further comprising generating a particular display, for a particular skill of the plurality of skills, that that reflects how many courses that teach the particular skill.

9. The method of claim 1 further comprising:
generating a particular display for a particular skill of the plurality of skills, and
providing a control on the particular display, which when activated, creates a page for uploading content for a course to teach the particular skill.

10. A method comprising:
obtaining, for a plurality of skills, a set of possessed-proficiency data that indicates a proficiency level currently possessed by each user of a plurality of users;
obtaining, for the plurality of skills, a set of required-proficiency data that indicates a proficiency level currently required by each job of a plurality of jobs;
for each skill of the plurality of skills, determining a demand based, at least in part, on the set of possessed-proficiency data and the set of required-proficiency data; and
generating a particular display, for a particular skill of the plurality of skills, that includes information that reflects the demand for the particular skill; and
wherein the method is performed by one or more processors.

11. The method of claim 10 wherein the information that reflects demand includes information that reflects a number of open positions that require the particular skill.

12. The method of claim 10 wherein the information that reflects demand includes information that reflects how many users, of the plurality of users, need greater proficiency in the particular skill to qualify for a job of the plurality of jobs.

13. One or more non-transitory computer-readable medium storing instructions which, when executed by one or more processors, cause performance of a method comprising:
obtaining, for a plurality of skills, a set of possessed-proficiency data that indicates a proficiency level currently possessed by each user of a plurality of users;
obtaining, for the plurality of skills, a set of required-proficiency data that indicates a proficiency level currently required by each job of a plurality of jobs;
for each skill of the plurality of skills, determining a demand based, at least in part, on the set of possessed-proficiency data and the set of required-proficiency data; and
ranking the plurality of skills based on the demand for each skill.

14. The one or more non-transitory computer-readable medium of claim 13, the method further comprising generating a particular display, for a particular skill of the plurality of skills, that includes information that reflects the demand for the particular skill.

15. The one or more non-transitory computer-readable medium of claim 14 wherein the information that reflects demand includes information that reflects a number of open positions that require the particular skill.

16. The one or more non-transitory computer-readable medium of claim 14 wherein the information that reflects demand includes information that reflects how many users, of the plurality of users, need greater proficiency in the particular skill to qualify for a job of the plurality of jobs.

17. The one or more non-transitory computer-readable medium of claim 13, the method further comprising generating a particular display, for a particular skill of the plurality of skills, that includes information that reflects an average rating of a set of courses that teach the particular skill.

18. The one or more non-transitory computer-readable medium of claim 17, wherein the average rating is based, at least in part, on a rating given by students that have taken one or more courses in the set of courses.

19. The one or more non-transitory computer-readable medium of claim 17, wherein the average rating is based, at least in part, on a rating given by employers to one or more courses in the set of courses.

20. The one or more non-transitory computer-readable medium of claim 13, the method further comprising generating a particular display, for a particular skill of the plurality of skills, that that reflects how many courses that teach the particular skill.

21. The one or more non-transitory computer-readable medium of claim 13, the method further comprising:
generating a particular display for a particular skill of the plurality of skills, and
providing a control on the particular display, which when activated, creates a page for uploading content for a course to teach the particular skill.

22. One or more non-transitory computer-readable medium storing instructions which, when executed by one or more processors, cause performance of a method comprising:
obtaining, for a plurality of skills, a set of possessed-proficiency data that indicates a proficiency level currently possessed by each user of a plurality of users;
obtaining, for the plurality of skills, a set of required-proficiency data that indicates a proficiency level currently required by each job of a plurality of jobs;
for each skill of the plurality of skills, determining a demand based, at least in part, on the set of possessed-proficiency data and the set of required-proficiency data; and
generating a particular display, for a particular skill of the plurality of skills, that includes information that reflects the demand for the particular skill.

23. The one or more non-transitory computer-readable medium of claim 22 wherein the information that reflects demand includes information that reflects a number of open positions that require the particular skill.

24. The one or more non-transitory computer-readable medium of claim 22 wherein the information that reflects demand includes information that reflects how many users, of the plurality of users, need greater proficiency in the particular skill to qualify for a job of the plurality of jobs.
